(19) United States
(12) Patent Application Publication
(10) Pub. No.: US 2025/0350051 A1
(43) Pub. Date: Nov. 13, 2025

(54) CARD EDGE CONNECTOR

(71) Applicant: TE Connectivity Solutions GmbH, Schaffhausen (CH)

(72) Inventors: Randall Robert Henry, Middletown, PA (US); Brandon Michael Matthews, Middletown, PA (US)

(21) Appl. No.: 18/659,169

(22) Filed: May 9, 2024

(51) Int. Cl. H01R 12/71; H01R 12/72; H01R 13/6587

(52) U.S. Cl. CPC H01R 12/716; H01R 12/724; H01R 13/6587

(57) ABSTRACT

A card edge connector includes a housing having a card slot at a mating end that receives a card edge of a circuit card. The card edge connector includes a contact assembly having first and second contact subassemblies each including contacts held by a contact holder including signal contacts arranged in pairs and ground contacts located between the pairs. The contact subassembly includes a shield structure coupled to the ground contacts. The shield structure and the ground contacts provide circumferential shielding around each pair of the signal contacts through the contact holder.

### BACKGROUND OF THE INVENTION

The subject matter herein relates generally to card edge connectors.

Electrical connectors are used in communication systems to electrically connect various components of the system. Some known electrical connectors are used to directly connect a first circuit board and a second circuit board. For example, the electrical connector may be a card edge connector mounted to a first circuit board and having a card slot that receives an edge portion of the second circuit board. Contacts of the card edge connector electrically connect the first circuit board to the second circuit board. Card edge connectors typically include many contacts arranged in rows on opposite sides of the card slot. The card edge connectors have high contact density, locating the contacts relatively close to each other. As data rates increase, signal integrity may be degraded by lack of efficient electrical shielding. Known card edge connectors utilize ground contacts between corresponding signal contacts to provide shielding between the signal contacts. However, at high data rates, the shielding provided by the ground contacts may be ineffective.

A need remains for a card edge connector having improved electrical shielding for improved signal integrity, particularly at high data rates.

### BRIEF DESCRIPTION OF THE INVENTION

In one embodiment, a card edge connector is provided and includes a housing which includes a chamber and a card slot at a mating end of the housing configured to receive a card edge of a circuit card. The card edge connector includes a contact assembly received in the chamber for connection to the card edge plugged into the card slot. The contact assembly includes a first contact subassembly and a second contact subassembly. The first contact subassembly includes an array of first contacts held by a first contact holder. The first contacts pass through the first contact holder. The first contacts include first ground contacts and first signal contacts. The first signal contacts arranged in pairs. The first ground contacts are located between the pairs of the first signal contacts. The first contact subassembly includes a first shield structure coupled to the first ground contacts. The first shield structure and the first ground contacts provide circumferential shielding around each pair of the first signal contacts through the first contact holder. The second contact subassembly includes an array of second contacts held by a second contact holder. The second contacts pass through the second contact holder. The second contacts include second ground contacts and second signal contacts. The second signal contacts arranged in pairs. The second ground contacts are located between the pairs of the second signal contacts. The second contact subassembly includes a second shield structure coupled to the second ground contacts. The second shield structure and the second ground contacts provide circumferential shielding around each pair of the second signal contacts through the second contact holder.

In another embodiment, a card edge connector is provided and includes a housing which includes a chamber and a card slot at a mating end of the housing configured to receive a card edge of a circuit card. The card edge connector includes a contact assembly received in the chamber for connection to the card edge plugged into the card slot. The contact assembly includes a contact subassembly includes an array of contacts held by a contact holder. The contact holder includes an inner side and an outer side. The contacts pass through the contact holder generally parallel to the inner side and the outer side. The contacts include ground contacts and signal contacts. The signal contacts arranged in pairs. The ground contacts are located between the pairs of the signal contacts. The contact subassembly includes an inner shield arranged at the inner side and an outer shield arranged at the outer side. The inner shield includes inner connecting elements electrically connected to the ground contacts. The outer shield includes outer connecting elements electrically connected to the ground contacts.

In a further embodiment, a card edge connector is provided and includes a housing which includes a chamber and a card slot at a mating end of the housing configured to receive a card edge of a circuit card. The card edge connector includes a contact assembly received in the chamber for connection to the card edge plugged into the card slot. The contact assembly includes a first contact subassembly and a second contact subassembly. The first contact subassembly includes an array of first contacts held by a first contact holder. The first contacts pass through the first contact holder. The first contact holder includes a first inner side and a first outer side. The first contacts pass through the first contact holder generally parallel to the first inner side and the first outer side. The first contacts include first ground contacts and first signal contacts. The first signal contacts arranged in pairs. The first ground contacts are located between the pairs of the first signal contacts. The first contact subassembly includes a first inner shield arranged at the first inner side and a first outer shield arranged at the first outer side. The first inner shield includes first inner connecting elements electrically connected to the first ground contacts. The first outer shield includes first outer connecting elements electrically connected to the first ground contacts. The first inner shield. The first outer shield, and the first ground contacts provide circumferential shielding around each pair of the first signal contacts through the first contact holder. The second contact subassembly includes an array of second contacts held by a second contact holder. The second contacts pass through the second contact holder. The second contact holder includes a second inner side and a second outer side. The second contacts pass through the second contact holder generally parallel to the second inner side and the second outer side. The second contacts include second ground contacts and second signal contacts. The second signal contacts arranged in pairs. The second ground contacts are located between the pairs of the second signal contacts. The second contact subassembly includes a second inner shield arranged at the second inner side and a second outer shield arranged at the second outer side. The second inner shield includes second inner connecting elements electrically connected to the second ground contacts. The second outer shield includes second outer connecting elements electrically connected to the second ground contacts. The second inner shield. The second outer shield, and the second ground contacts provide circumferential shielding around each pair of the second signal contacts through the second contact holder.

### BRIEF DESCRIPTION OF THE DRAWINGS

FIG. 1 is a perspective view of a communication system in accordance with an exemplary embodiment.

FIG. 2 is a perspective view of the contact assembly in accordance with an exemplary embodiment.

FIG. 3 is a perspective view of the first inner shield of the first contact subassembly in accordance with an exemplary embodiment.

FIG. 4 is a perspective view of the first outer shield of the first contact subassembly in accordance with an exemplary embodiment.

FIG. 5 is a perspective view of a portion of the first contact subassembly in accordance with an exemplary embodiment.

FIG. 6 is a perspective view of the inner side of the first contact subassembly in accordance with an exemplary embodiment.

FIG. 7 is a perspective view of an outer side of the first contact subassembly in accordance with an exemplary embodiment.

FIG. 8 is a perspective view of the second inner shield of the second contact subassembly in accordance with an exemplary embodiment.

FIG. 9 is a perspective view of the second outer shield of the second contact subassembly in accordance with an exemplary embodiment.

FIG. 10 is a perspective view of a portion of the second contact subassembly in accordance with an exemplary embodiment.

FIG. 11 is a perspective view of the inner side of the second contact subassembly in accordance with an exemplary embodiment.

FIG. 12 is a perspective view of an outer side of the second contact subassembly in accordance with an exemplary embodiment.

FIG. 13 is a sectional view of the card edge connector in accordance with an exemplary embodiment.

FIG. 14 is a cross-sectional view of a portion of the card edge connector showing the contact assembly in the chamber of the housing in accordance with an exemplary embodiment.

### DETAILED DESCRIPTION OF THE INVENTION

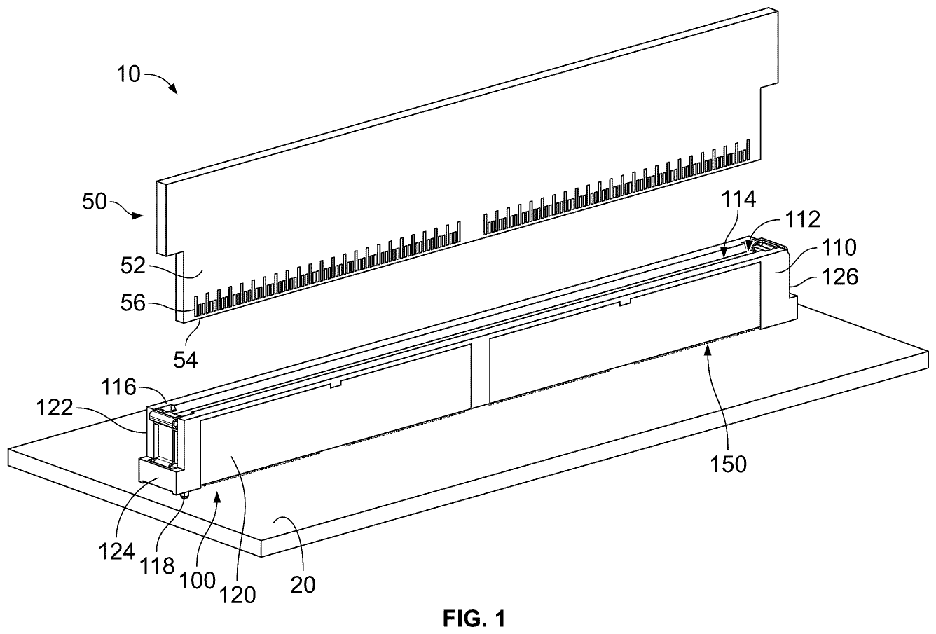

FIG. 1 is a perspective view of a communication system 10 in accordance with an exemplary embodiment. The communication system 10 includes a card edge connector 100 configured to be electrically connected to a pluggable module 50. The pluggable module 50 is configured to be plugged into a mating end of the card edge connector 100. In an exemplary embodiment, the card edge connector 100 is configured be mounted to a host circuit board 20 of the communication system 10. For example, the card edge connector 100 may be mounted to a top side of the host circuit board 20. In alternative embodiments, the card edge connector 100 may be a cable connector provided at ends of one or more cables (not shown).

The pluggable module 50 includes a circuit card 52 configured to be plugged into the card edge connector 100. The circuit card 52 includes a card edge 54 having card contacts 56 proximate to the card edge 54. The card contacts 56 may be provided along both sides of the circuit card 52 proximate to the card edge 54. The card edge 54 is configured to be plugged into a card slot at the mating end of the card edge connector 100. The pluggable module 50 may include a housing or shell surrounding the circuit card 52 configured to be mated with the card edge connector 100. The pluggable module 50 may include securing features, such as latching features configured to be secured to the card edge connector 100. In the illustrated embodiment, the circuit card 52 is configured be plugged into the card edge connector 100 in a plug in direction oriented orthogonal (for example, perpendicular) to the host circuit board 20. For example, the circuit card 52 may be oriented vertically and the host circuit board 20 may be oriented horizontally. Other orientations are possible in alternative embodiments. For example, the card edge connector 100 may be a right angle connector such that the circuit card 52 may be plugged into the card edge connector 100 in a direction generally parallel to the host circuit board 20.

The card edge connector 100 includes a housing 110 having a chamber 112 that holds one or more contact assemblies 150, such as four contact assemblies 150 stacked side-by-side in the chamber 112. In an exemplary embodiment, the housing 110 is manufactured from a dielectric material, such as a plastic material. The housing 110 may be injection molded. Optionally, the housing 110 may be manufactured from multiple pieces, such as an outer housing and an inner housing received in the outer housing.

The housing 110 includes a card slot 114 at the mating end of the card edge connector 100. In the illustrated embodiment, the card slot 114 is provided at a top 116 of the housing 110. Other locations are possible in alternative embodiments. In an exemplary embodiment, a bottom 118 of the housing 110 is configured to be mounted to the host circuit board 20. The housing 110 includes a front 120 and a rear 122. The housing 110 includes a first side 124 and the second side 126. In an exemplary embodiment, the housing 110 is elongated between the sides 124, 126. For example, the front 120 and the rear 122 are longer than the first and second sides 124, 126. In the illustrated embodiment, the housing 110 is generally rectangular. However, the housing 110 may have other shapes in alternative embodiments. The housing 110 may include securing features, such as latches, used to secure the circuit card 52 in the card slot 114.

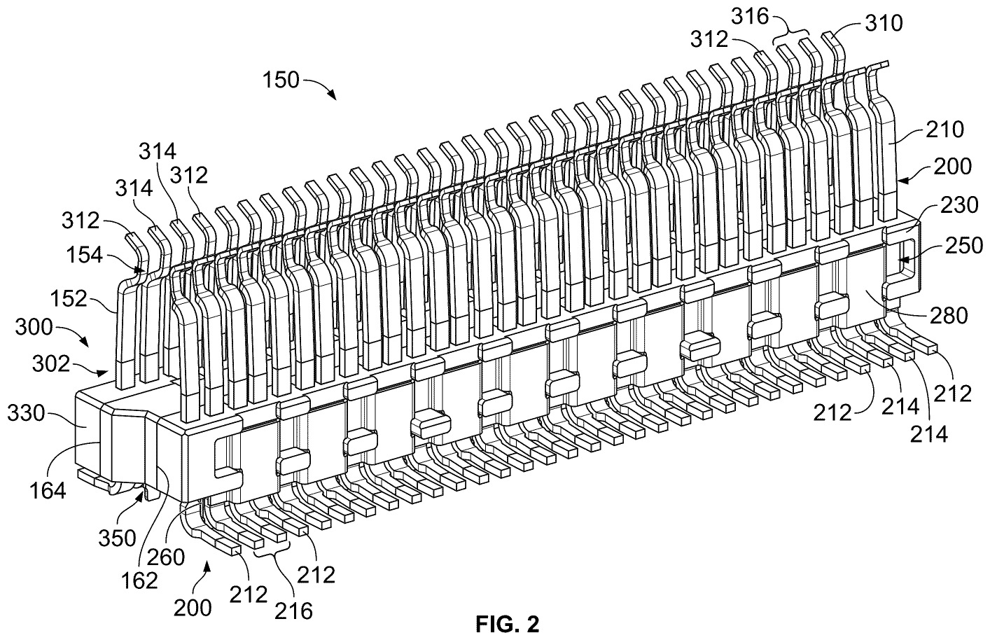

FIG. 2 is a perspective view of the contact assembly 150 in accordance with an exemplary embodiment. The contact assembly 150 includes a plurality of contacts 152 configured to be electrically connected to the pluggable module 50. For example, the contacts 152 may be electrically connected to the corresponding card contacts 56 of the circuit card 52 when the circuit card 52 is plugged into the card edge connector 100. In an exemplary embodiment, the contacts 152 are arranged in multiple rows on opposite sides of a card space 154 configured to interface with opposite sides of the circuit card 52. The circuit card 52 is configured to be plugged into the card space 154 between the rows of the contacts 152. The mating ends of the contacts 152 form a separable mating interfaces configured to interface with the card contacts 56. For example, the mating ends of the contacts 152 may include spring beams configured to interface with the card contacts 56. In an exemplary embodiment, the contacts 152 are configured to be terminated to the host circuit board 20. For example, ends of the contacts 152 may be soldered to the host circuit board 20.

In an exemplary embodiment, the contact assembly 150 includes a first contact subassembly 200 and a second contact subassembly 300 at opposite sides of the contact assembly 150. The first and second contact assemblies 200, 300 may be similar to each other, such as mirrored versions of each other and inverted 180° on opposite sides of the contact assembly 150. Components of the first contact subassembly 200 may be identified or denoted using the designator “first” and/or with reference numerals in the 200's and components of the second contact subassembly 300 may be identified or denoted using the designator “second” to differentiate/identify between the various components and/or with reference numerals in the 300's.

In an exemplary embodiment, the contact assembly 150 includes a contact spacer 160 positioned between the first and second contact assemblies 200, 300. The contact spacer 160 holds relative positions of the first and second contact assemblies 200, 300, such as to control spacing of the contacts 152 in the rows on opposite sides of the card space 154. The contact spacer 160 may be a molded part, such as an injection molded part. The contact spacer 160 extends between a first side 162 and a second side 164. The first contact subassembly 200 is coupled to the first side 162. The second contact subassembly 300 is coupled to the second side 164. The contact spacer 160 has a thickness between the first and second sides 162, 164. The thickness is selected to control the spacing between the first and second contact assemblies 200, 300, such as to control the width of the card space 154.

The first contact subassembly 200 includes an array 202 of first contacts 210 held by a first contact holder 230. The first contacts 210 pass through the first contact holder 230. The first contact holder 230 holds relative positions of the first contacts 210. In an exemplary embodiment, the first contacts 210 include first ground contacts 212 and first signal contacts 214. The first signal contacts 214 are arranged in pairs 216. The first ground contacts 212 are located between the pairs 216 of the first signal contacts 214. The first contact subassembly 200 includes a first shield structure 250 coupled to the first ground contacts 212. The first shield structure 250 and the first ground contacts 212 providing circumferential shielding around each pair of the first signal contacts 214 through the first contact holder 230.

In an exemplary embodiment, the first shield structure 250 is a multipiece shield structure. For example, the first shield structure 250 includes a first inner shield 260 extending along an inner side of the first contact holder 230 and a first outer shield 280 extending along an outer side of the first contact holder 230. The inner shield 260 and the outer shield 280 provide shielding along opposite sides of the first signal contacts 214. The inner shield 260 and the outer shield 280 are electrically connected to each of the first ground contacts 212 to electrically common the first shield structure 250 and the first ground contacts 212. In an exemplary embodiment, the first shield structure 250 is electrically connected to the host circuit board 20, such as to a ground plane of the host circuit board 20, independent of the first ground contacts 212.

The second contact subassembly 300 includes an array 302 of second contacts 310 held by a second contact holder 330. The second contacts 310 pass through the second contact holder 330. The second contact holder 330 holds relative positions of the second contacts 310. In an exemplary embodiment, the second contacts 310 include second ground contacts 312 and second signal contacts 314. The second signal contacts 314 are arranged in pairs 316. The second ground contacts 312 are located between the pairs 316 of the second signal contacts 314. The second contact subassembly 300 includes a second shield structure 350 coupled to the second ground contacts 312. The second shield structure 350 and the second ground contacts 312 providing circumferential shielding around each pair of the second signal contacts 314 through the second contact holder 330.

In an exemplary embodiment, the second shield structure 350 is a multipiece shield structure. For example, the second shield structure 350 includes a second inner shield 360 extending along an inner side of the second contact holder 330 and a second outer shield 380 extending along an outer side of the second contact holder 330. The inner shield 360 and the outer shield 380 provide shielding along opposite sides of the second signal contacts 314. The inner shield 360 and the outer shield 380 are electrically connected to each of the second ground contacts 312 to electrically common the second shield structure 350 and the second ground contacts 312. In an exemplary embodiment, the second shield structure 350 is electrically connected to the host circuit board 30, such as to a ground plane of the host circuit board 30, independent of the second ground contacts 312.

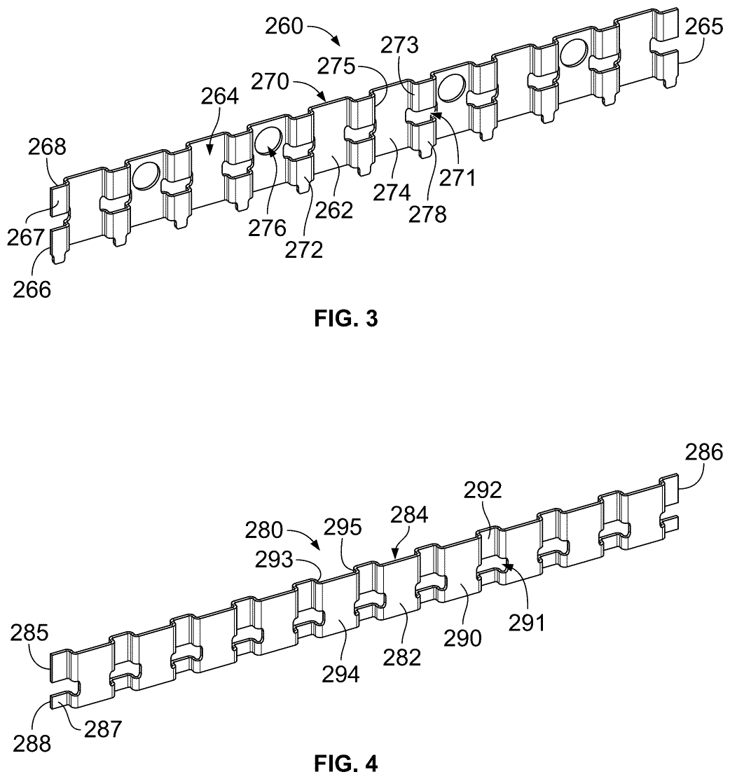

FIG. 3 is a perspective view of the first inner shield 260 of the first contact subassembly 200 in accordance with an exemplary embodiment. The second inner shield 360 of the second contact subassembly 300 (FIG. 2) may be similar to the first inner shield 260 and like components may be identified with similar reference numerals.

The inner shield 260 includes a panel 262 forming a series of pockets 264 between a first end 265 and a second end 266. The inner shield 260 includes a first side 267 and a second side 268. The first side 267 is an inner side configured to face the first contact holder 230. In an exemplary embodiment, the panel 262 of the inner shield 260 is stamped and formed from a metal sheet. For example, the panel 262 may be stamped from a copper sheet or an aluminum sheet. The panel 262 is electrically conductive to provide electrical shielding for the first signal contacts 214. The pockets 264 are configured to receive the corresponding first signal contacts 214. For example, the pockets 264 may be sized to receive a pair of the first signal contacts 214 and/or the portion of the contact holder 230 surrounding the pair of the first signal contacts 214.

In an exemplary embodiment, the inner shield 260 is nonplanar. For example, the inner shield 260 includes undulations forming the pockets 264. In an exemplary embodiment, the inner shield 260 includes a series of covers 270 and connecting walls 272 between the covers 270. The connecting walls 272 are configured to be connected to corresponding ground contacts 212. For example, the connecting walls 272 may be welded, soldered, or connected by a compression interface or using conductive adhesive or conductive epoxy. The connecting walls 272 are coplanar with each other along the first side 267 of the inner shield 260. The inner shield 260 is electrically connected to each of the ground contacts 212 at the corresponding connecting walls 272. In various embodiments, the connecting walls 272 include openings 271. The openings 271 are configured to receive portions of the contact holder 230.

The covers 270 form the pockets 264. The covers 270 extend to the second side 268 of the inner shield 260. In an exemplary embodiment, each covers 270 includes an end wall 274 and side walls 273, 275 extending from opposite sides of the end wall 274. The end wall 274 and the side walls 273, 275 define the corresponding pocket 264. The end wall 274 may be generally planar. Optionally, each of the end walls 274 are coplanar with each other. In other various embodiments, the end wall 274 may be nonplanar, such as including curved or angled surfaces. The side walls 273, 275 extend between the end wall 274 and the corresponding connecting walls 272. The side walls 273, 275 may be oriented generally perpendicular to the end wall 274 and/or the connecting walls 272. In other embodiments, the side walls 273, 275 may be angled, such as at an angle between 90° and 160° relative to the end wall 274. The lengths of the side walls 273, 275 dictate the depth of the pockets 264. The openings 271 may extend into the side walls 273, 275 and/or the end walls 274. In an exemplary embodiment, one or more of the end walls 274 include alignment openings 276 used to align the inner shield 260 to the contact holder 230 and/or to receive a connecting post used to connect the contact holder 230 and the contact spacer 160.

In an exemplary embodiment, the inner shield 260 includes terminating elements 278 extending from the bottom of the panel 262. The terminating elements 278 are used to directly electrically connect the inner shield 260 to the host circuit board 20 (FIG. 1), such as independent of the ground contacts. For example, the terminating elements 278 include posts or pins configured to be received in plated vias of the host circuit board 20. The terminating elements 278 are configured to be soldered to the plated vias of the host circuit board 20. The terminating elements 278 define direct electrical path between the inner shield 260 and the host circuit board 20, such as to a ground plane of the host circuit board 20. The terminating elements 278 provide grounding paths to the host circuit board 20 independent of the ground contacts 212. In the illustrated embodiment, the terminating elements 278 extend from the connecting walls 272. Optionally, each of the connecting walls 272 may include the corresponding terminating element 278. The terminating elements 278 may additionally or alternatively extend from the end walls 274 in alternative embodiments.

FIG. 4 is a perspective view of the first outer shield 280 of the first contact subassembly 200 in accordance with an exemplary embodiment. The second outer shield 380 of the second contact subassembly 300 (FIG. 2) may be similar to the first outer shield 280 and like components may be identified with similar reference numerals.

The outer shield 280 includes a panel 282 forming a series of pockets 284 between a first end 285 and a second end 286. The outer shield 280 includes a first side 287 and a second side 288. The first side 287 is an inner side configured to face the first contact holder 230. In an exemplary embodiment, the panel 282 of the outer shield 280 is stamped and formed from a metal sheet. For example, the panel 282 may be stamped from a copper sheet or an aluminum sheet. The panel 282 is electrically conductive to provide electrical shielding for the first signal contacts 214. The pockets 284 are configured to receive the corresponding first signal contacts 214. For example, the pockets 284 may be sized to receive a pair of the first signal contacts 214 and/or the portion of the contact holder 230 surrounding the pair of the first signal contacts 214.

In an exemplary embodiment, the outer shield 280 is nonplanar. For example, the outer shield 280 includes undulations forming the pockets 284. In an exemplary embodiment, the outer shield 280 includes a series of covers 290 and connecting walls 292 between the covers 290. The connecting walls 292 are configured to be connected to corresponding ground contacts 212. For example, the connecting walls 292 may be welded, soldered, or connected by a compression interface or using conductive adhesive or conductive epoxy. The connecting walls 292 are coplanar with each other along the first side 287 of the outer shield 280. The outer shield 280 is electrically connected to each of the ground contacts 212 at the corresponding connecting walls 292. In various embodiments, the connecting walls 292 include openings 291. The openings 291 are configured to receive portions of the contact holder 230.

The covers 290 form the pockets 284. The covers 290 extend to the second side 288 of the outer shield 280. In an exemplary embodiment, each covers 290 includes an end wall 294 and side walls 293, 295 extending from opposite sides of the end wall 294. The end wall 294 and the side walls 293, 295 define the corresponding pocket 284. The end wall 294 may be generally planar. Optionally, each of the end walls 294 are coplanar with each other. In other various embodiments, the end wall 294 may be nonplanar, such as including curved or angled surfaces. The side walls 293, 295 extend between the end wall 294 and the corresponding connecting walls 292. The side walls 293, 295 may be oriented generally perpendicular to the end wall 294 and/or the connecting walls 292. In other embodiments, the side walls 293, 295 may be angled, such as at an angle between 90° and 160° relative to the end wall 294. The lengths of the side walls 293, 295 dictate the depth of the pockets 284. The openings 291 may extend into the side walls 293, 295 and/or the end walls 294.

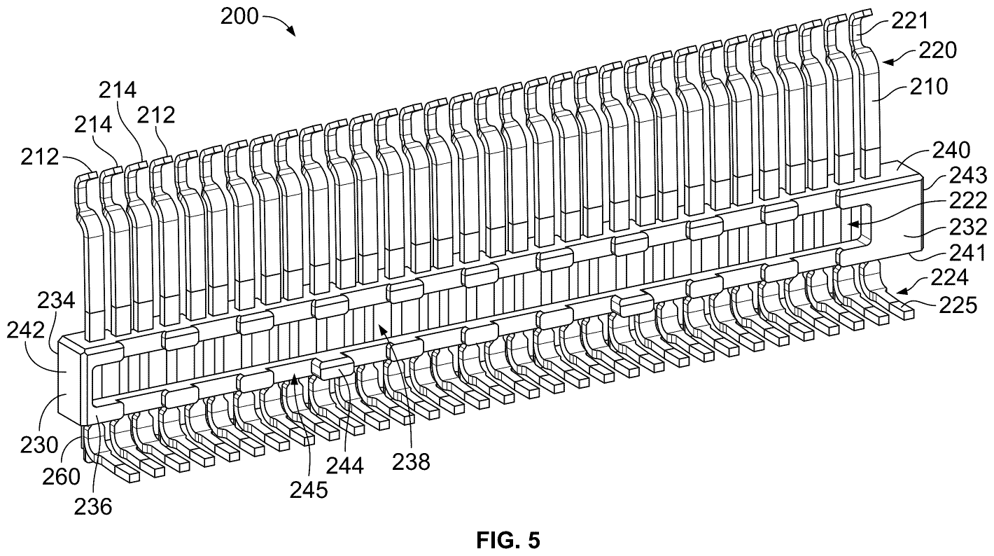

FIG. 5 is a perspective view of a portion of the first contact subassembly 200 in accordance with an exemplary embodiment. FIG. 5 shows the first contact subassembly 200 with the outer shield 280 (FIG. 4) removed to illustrate components of the first contact subassembly 200.

The first contact subassembly 200 includes the first contacts 210 held in a row by the first contact holder 230. The first contacts 210 include the first ground contacts 212 and the first signal contacts 214. In an exemplary embodiment, the first signal contacts 214 are arranged in pairs with the first ground contacts 212 located between the pairs of the first signal contacts 214 (for example, in a G-S-S-G arrangement). In an exemplary embodiment, the first contacts 210 are stamped and formed contacts. The first contacts 210 may be formed from a lead frame, such as being stamped from a common sheet of metal. In an exemplary embodiment, the contact holder 230 is overmolded over the lead frame to hold the relative positions of the first contacts 210.

Each first contact 210 includes a mating end 220, a terminating end 224, and an intermediate portion 222 between the mating end 220 and the terminating end 224. The intermediate portion 222 is held in the contact holder 230. The intermediate portion 222 passes through the contact holder 230. The mating end 220 extends from the top of the contact holder 230. The mating end 220 is configured to be mated to the circuit card 52 (FIG. 1). For example, the mating end 220 includes a spring beam 221 configured to be electrically connected to the corresponding card contact 56 of the circuit card 52. The spring beams 221 are deflectable. The spring beams 221 have separable mating interfaces. In an exemplary embodiment, the ends of the spring beams 221 are curved to form the separable mating interface. The ends of the spring beams 221 have short tips beyond the separable mating interfaces to reduce lengths of electrical stubs. The terminating end 224 extends from the bottom of the contact holder 230. The terminating end 224 is configured to be electrically connected to the host circuit board 20 (FIG. 1). For example, the terminating end 224 includes a solder tail 225 configured to be soldered to a pad or trace on the host circuit board 20.

The contact holder 230 includes a holder body 232 manufactured from a dielectric material, such as a plastic material. The holder body 232 may be a molded part, such as being injection molded. In an exemplary embodiment, the holder body 232 may be an overmold body configured to be overmolded over the intermediate portions 222 of the first contacts 210. The contact holder 230 extends between an inner side 234 and an outer side 236. The contact holder 230 may include openings 238 at the inner side 234 and/or the outer side 236 the contacts 210 may be exposed through the openings 238. In an exemplary embodiment, the ground contacts 212 are exposed in the openings 238 to allow electrical connection of the inner shield 260 and the outer shield 280 to the corresponding ground contacts 212 through the openings 238.

The contact holder 230 extends between a top 240 and a bottom 241. The contact holder 230 extends between a first end 242 and a second end 243. The contact holder 230 is elongated between the first and second ends 242, 243. For example, the sides 234, 236 may be longer than the ends 242, 243.

In an exemplary embodiment, the contact holder 230 includes locating features 244 at the inner side 234 and/or the outer side 236. The locating features 244 are used to locate the inner shield 260 at the inner side 234 and/or to locate the outer shield 280 at the outer side 236. In an exemplary embodiment, the locating features 244 include protrusions extending from the sides of the contact holder 230. Other types of locating features may be used in alternative embodiments. In an exemplary embodiment, the pockets 245 are defined between the locating features 244. The pockets 245 may receive portions of the inner shield 260/outer shield 280.

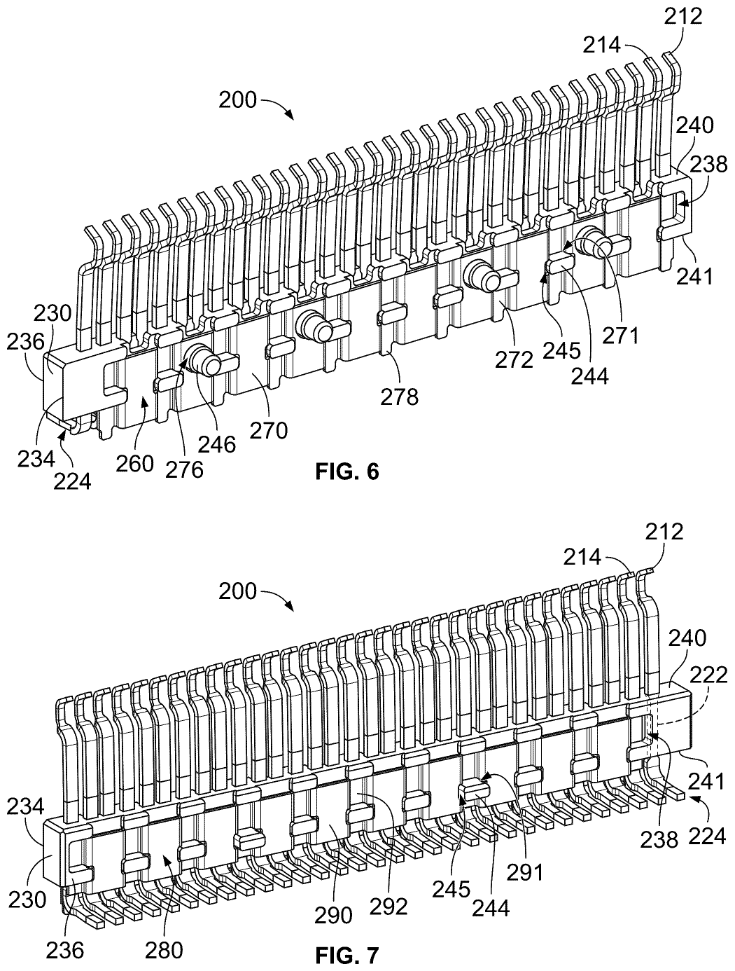

FIG. 6 is a perspective view of the inner side of the first contact subassembly 200 in accordance with an exemplary embodiment. FIG. 7 is a perspective view of an outer side of the first contact subassembly 200 in accordance with an exemplary embodiment. FIGS. 6 and 7 illustrate the inner and outer shields 260, 280 coupled to the inner and outer sides 234, 236 of the contact holder 230. The inner and outer shields 260, 280 provide shielding for the signal contacts 214. The inner and outer shields 260, 280 in addition to the ground contacts 212, provide circumferential shielding around each of the pairs of the signal contacts 214. For example, the ground contacts 212 provide shielding between the pairs of the signal contacts 214 and the inner and outer shields 260, 280 provide shielding along the inner and outer sides of the pair of the signal contacts 214.

When assembled, the inner shield 260 is coupled to the inner side 234 of the contact holder 230. In an exemplary embodiment, locating elements 246 extend from the inner side 234 of the contact holder 230. The locating elements 246 are received in the alignment openings 276 of the inner shield 260. The locating elements 246 may be used to locate and/or position the first contact subassembly 200 relative to the contact spacer 160 (shown in FIG. 2). The locating elements 246 may be posts or pins configured to be received in openings in the contact spacer 160. The locating elements 246 may be heat staked to the contact spacer 160. The locating elements 246 may include crush ribs to form an interference fit with the contact spacer 160. The inner shield 260 is coupled to the locating features 244. For example, the locating features 244 pass through the openings 271 in the inner shield 260. The covers 270 are located in the pockets 245 between the locating features 244. The connecting walls 272 extend into the opening 238 in the contact holder 230 to interface with the corresponding ground contacts 212. The connecting walls 272 may be welded, such as laser welded, to the ground contacts 212.

The inner shield 260 provides electrical shielding along the intermediate portions 222 of the signal contacts 214. For example, the inner shield 260 provides electrical shielding along the inner side 234 of the contact holder 230. The inner shield 260 may provide shielding below the bottom 241 of the contact holder 230 and/or above the top 240 of the contact holder 230. In the illustrated embodiment, the inner shield 260 extends to a location just below the top 240 of the contact holder 230, but extends for a distance below the bottom 241 of the contact holder 230 to provide shielding along portions of the terminating ends 224 of the signal contacts 214. The terminating elements 278 extend from the bottom of the inner shield 260 and are configured to be terminated to the host circuit board 20.

When assembled, the outer shield 280 is coupled to the outer side 236 of the contact holder 230. The outer shield 280 is coupled to the locating features 244. For example, the locating features 244 pass through the openings 291 in the outer shield 280. The covers 290 are located in the pockets 245 between the locating features 244. The connecting walls 292 extend into the opening 238 in the contact holder 230 to interface with the corresponding ground contacts 212. The connecting walls 292 may be welded, such as laser welded, to the ground contacts 212.

The outer shield 280 provides electrical shielding along the intermediate portions 222 of the signal contacts 214. For example, the outer shield 280 provides electrical shielding along the outer side 236 of the contact holder 230. The outer shield 280 may provide shielding below the bottom 241 of the contact holder 230 and/or above the top 240 of the contact holder 230. In the illustrated embodiment, the outer shield 280 extends to a location just below the top 240 of the contact holder 230, but extends for a distance below the bottom 241 of the contact holder 230 to provide shielding along portions of the terminating ends 224 of the signal contacts 214.

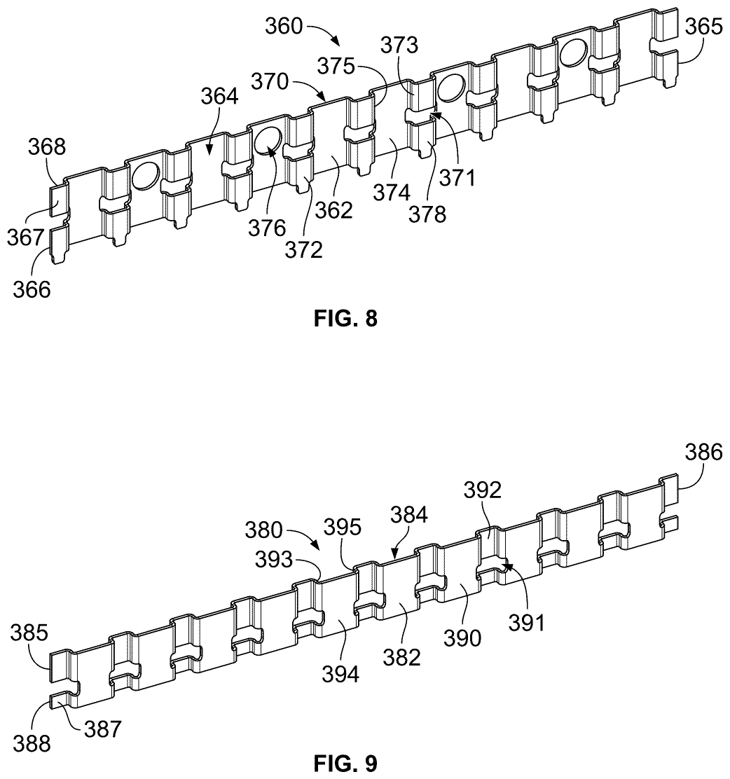

FIG. 8 is a perspective view of the second inner shield 360 of the second contact subassembly 300 in accordance with an exemplary embodiment. The second inner shield 360 may be similar to the first inner shield 260 (FIG. 3) and like components may be identified with similar reference numerals.

The inner shield 360 includes a panel 362 forming a series of pockets 364 between a first end 365 and a second end 366. The inner shield 360 includes a first side 367 and a second side 368. The first side 367 is an inner side configured to face the second contact holder 330. In an exemplary embodiment, the panel 362 of the inner shield 360 is stamped and formed from a metal sheet. For example, the panel 362 may be stamped from a copper sheet or an aluminum sheet. The panel 362 is electrically conductive to provide electrical shielding for the second signal contacts 314. The pockets 364 are configured to receive the corresponding second signal contacts 314. For example, the pockets 364 may be sized to receive a pair of the second signal contacts 314 and/or the portion of the contact holder 330 surrounding the pair of the second signal contacts 314.

In an exemplary embodiment, the inner shield 360 is nonplanar. For example, the inner shield 360 includes undulations forming the pockets 364. In an exemplary embodiment, the inner shield 360 includes a series of covers 370 and connecting walls 372 between the covers 370. The connecting walls 372 are configured to be connected to corresponding ground contacts 312. For example, the connecting walls 372 may be welded, soldered, or connected by a compression interface or using conductive adhesive or conductive epoxy. The connecting walls 372 are coplanar with each other along the first side 367 of the inner shield 360. The inner shield 360 is electrically connected to each of the ground contacts 312 at the corresponding connecting walls 372. In various embodiments, the connecting walls 372 include openings 371. The openings 371 are configured to receive portions of the contact holder 330.

The covers 370 form the pockets 364. The covers 370 extend to the second side 368 of the inner shield 360. In an exemplary embodiment, each covers 370 includes an end wall 374 and side walls 373, 375 extending from opposite sides of the end wall 374. The end wall 374 and the side walls 373, 375 define the corresponding pocket 364. The end wall 374 may be generally planar. Optionally, each of the end walls 374 are coplanar with each other. In other various embodiments, the end wall 374 may be nonplanar, such as including curved or angled surfaces. The side walls 373, 375 extend between the end wall 374 and the corresponding connecting walls 372. The side walls 373, 375 may be oriented generally perpendicular to the end wall 374 and/or the connecting walls 372. In other embodiments, the side walls 373, 375 may be angled, such as at an angle between 90° and 160° relative to the end wall 374. The lengths of the side walls 373, 375 dictate the depth of the pockets 364. The openings 371 may extend into the side walls 373, 375 and/or the end walls 374. In an exemplary embodiment, one or more of the end walls 374 include alignment openings 376 used to align the inner shield 360 to the contact holder 330 and/or to receive a connecting post used to connect the contact holder 330 and the contact spacer 160.

In an exemplary embodiment, the inner shield 360 includes terminating elements 378 extending from the bottom of the panel 362. The terminating elements 378 are used to electrically connect the inner shield 360 to the host circuit board 30 (FIG. 1). For example, the terminating elements 378 include posts or pins configured to be received in plated vias of the host circuit board 30. The terminating elements 378 are configured to be soldered to the plated vias of the host circuit board 30. The terminating elements 378 define direct electrical path between the inner shield 360 and the host circuit board 30, such as to a ground plane of the host circuit board 30. The terminating elements 378 provide grounding paths to the host circuit board 30 independent of the ground contacts 312. In the illustrated embodiment, the terminating elements 378 extend from the connecting walls 372. Optionally, each of the connecting walls 372 may include the corresponding terminating element 378. The terminating elements 378 may additionally or alternatively extend from the end walls 374 in alternative embodiments.

FIG. 9 is a perspective view of the second outer shield 380 of the second contact subassembly 300 in accordance with an exemplary embodiment. The second outer shield 380 may be similar to the first outer shield 280 (FIG. 4) and like components may be identified with similar reference numerals.

The outer shield 380 includes a panel 382 forming a series of pockets 384 between a first end 385 and a second end 386. The outer shield 380 includes a first side 387 and a second side 388. The first side 387 is an inner side configured to face the second contact holder 330. In an exemplary embodiment, the panel 382 of the outer shield 380 is stamped and formed from a metal sheet. For example, the panel 382 may be stamped from a copper sheet or an aluminum sheet. The panel 382 is electrically conductive to provide electrical shielding for the second signal contacts 314. The pockets 384 are configured to receive the corresponding second signal contacts 314. For example, the pockets 384 may be sized to receive a pair of the second signal contacts 314 and/or the portion of the contact holder 330 surrounding the pair of the second signal contacts 314.

In an exemplary embodiment, the outer shield 380 is nonplanar. For example, the outer shield 380 includes undulations forming the pockets 384. In an exemplary embodiment, the outer shield 380 includes a series of covers 390 and connecting walls 392 between the covers 390. The connecting walls 392 are configured to be connected to corresponding ground contacts 312. For example, the connecting walls 392 may be welded, soldered, or connected by a compression interface or using conductive adhesive or conductive epoxy. The connecting walls 392 are coplanar with each other along the first side 387 of the outer shield 380. The outer shield 380 is electrically connected to each of the ground contacts 312 at the corresponding connecting walls 392. In various embodiments, the connecting walls 392 include openings 391. The openings 391 are configured to receive portions of the contact holder 330.

The covers 390 form the pockets 384. The covers 390 extend to the second side 388 of the outer shield 380. In an exemplary embodiment, each covers 390 includes an end wall 394 and side walls 393, 395 extending from opposite sides of the end wall 394. The end wall 394 and the side walls 393, 395 define the corresponding pocket 384. The end wall 394 may be generally planar. Optionally, each of the end walls 394 are coplanar with each other. In other various embodiments, the end wall 394 may be nonplanar, such as including curved or angled surfaces. The side walls 393, 395 extend between the end wall 394 and the corresponding connecting walls 392. The side walls 393, 395 may be oriented generally perpendicular to the end wall 394 and/or the connecting walls 392. In other embodiments, the side walls 393, 395 may be angled, such as at an angle between 90° and 160° relative to the end wall 394. The lengths of the side walls 393, 395 dictate the depth of the pockets 384. The openings 391 may extend into the side walls 393, 395 and/or the end walls 394.

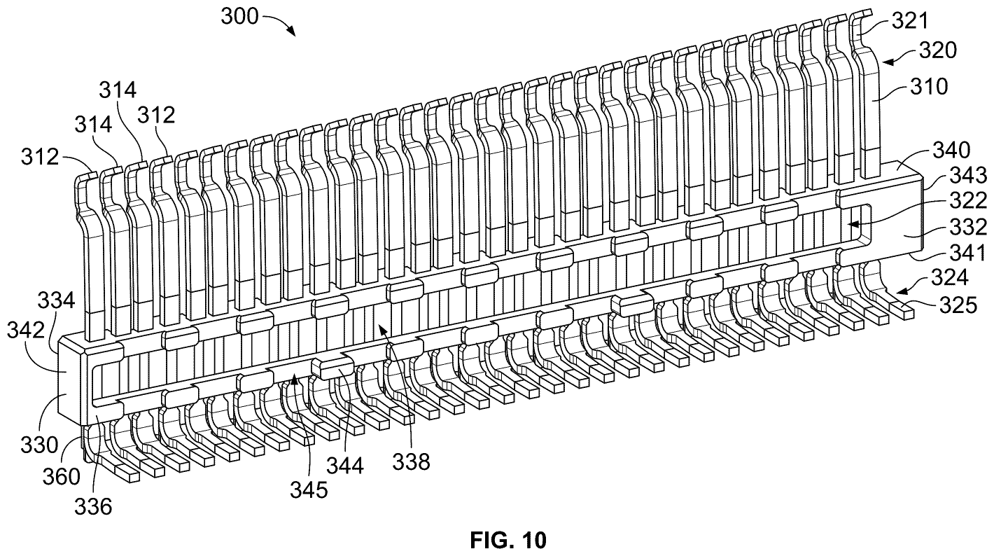

FIG. 10 is a perspective view of a portion of the second contact subassembly 300 in accordance with an exemplary embodiment. FIG. 10 shows the second contact subassembly 300 with the outer shield 380 (FIG. 9) removed to illustrate components of the second contact subassembly 300.

The second contact subassembly 300 includes the second contacts 310 held in a row by the second contact holder 330. The second contacts 310 include the second ground contacts 312 and the second signal contacts 314. In an exemplary embodiment, the second signal contacts 314 are arranged in pairs with the second ground contacts 312 located between the pairs of the second signal contacts 314 (for example, in a G-S-S-G arrangement). In an exemplary embodiment, the second contacts 310 are stamped and formed contacts. The second contacts 310 may be formed from a lead frame, such as being stamped from a common sheet of metal. In an exemplary embodiment, the contact holder 330 is overmolded over the lead frame to hold the relative positions of the second contacts 310.

Each second contact 310 includes a mating end 320, a terminating end 324, and an intermediate portion 322 between the mating end 320 and the terminating end 324. The intermediate portion 322 is held in the contact holder 330. The intermediate portion 322 passes through the contact holder 330. The mating end 320 extends from the top of the contact holder 330. The mating end 320 is configured to be mated to the circuit card 52 (FIG. 1). For example, the mating end 320 includes a spring beam 321 configured to be electrically connected to the corresponding card contact 56 of the circuit card 52. The spring beams 321 are deflectable. The spring beams 321 have separable mating interfaces. In an exemplary embodiment, the ends of the spring beams 321 are curved to form the separable mating interface. The ends of the spring beams 321 have short tips beyond the separable mating interfaces to reduce lengths of electrical stubs. The terminating end 324 extends from the bottom of the contact holder 330. The terminating end 324 is configured to be electrically connected to the host circuit board 30 (FIG. 1). For example, the terminating end 324 includes a solder tail 325 configured to be soldered to a pad or trace on the host circuit board 30.

The contact holder 330 includes a holder body 332 manufactured from a dielectric material, such as a plastic material. The holder body 332 may be a molded part, such as being injection molded. In an exemplary embodiment, the holder body 332 may be an overmold body configured to be overmolded over the intermediate portions 322 of the second contacts 310. The contact holder 330 extends between an inner side 334 and an outer side 336. The contact holder 330 may include openings 338 at the inner side 334 and/or the outer side 336 the contacts 310 may be exposed through the openings 338. In an exemplary embodiment, the ground contacts 312 are exposed in the openings 338 to allow electrical connection of the inner shield 360 and the outer shield 380 to the corresponding ground contacts 312 through the openings 338.

The contact holder 330 extends between a top 340 and a bottom 341. The contact holder 330 extends between a first end 342 and a second end 343. The contact holder 330 is elongated between the first and second ends 342, 343. For example, the sides 334, 336 may be longer than the ends 342, 343.

In an exemplary embodiment, the contact holder 330 includes locating features 344 at the inner side 334 and/or the outer side 336. The locating features 344 are used to locate the inner shield 360 at the inner side 334 and/or to locate the outer shield 380 at the outer side 336. In an exemplary embodiment, the locating features 344 include protrusions extending from the sides of the contact holder 330. Other types of locating features may be used in alternative embodiments. In an exemplary embodiment, the pockets 345 are defined between the locating features 344. The pockets 345 may receive portions of the inner shield 360/outer shield 380.

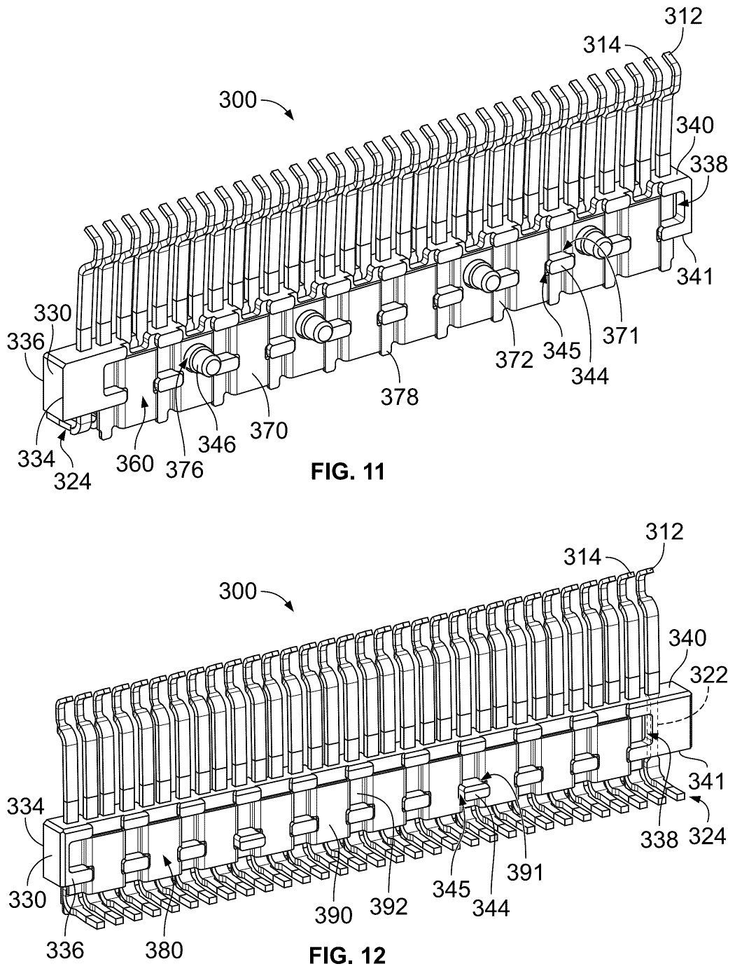

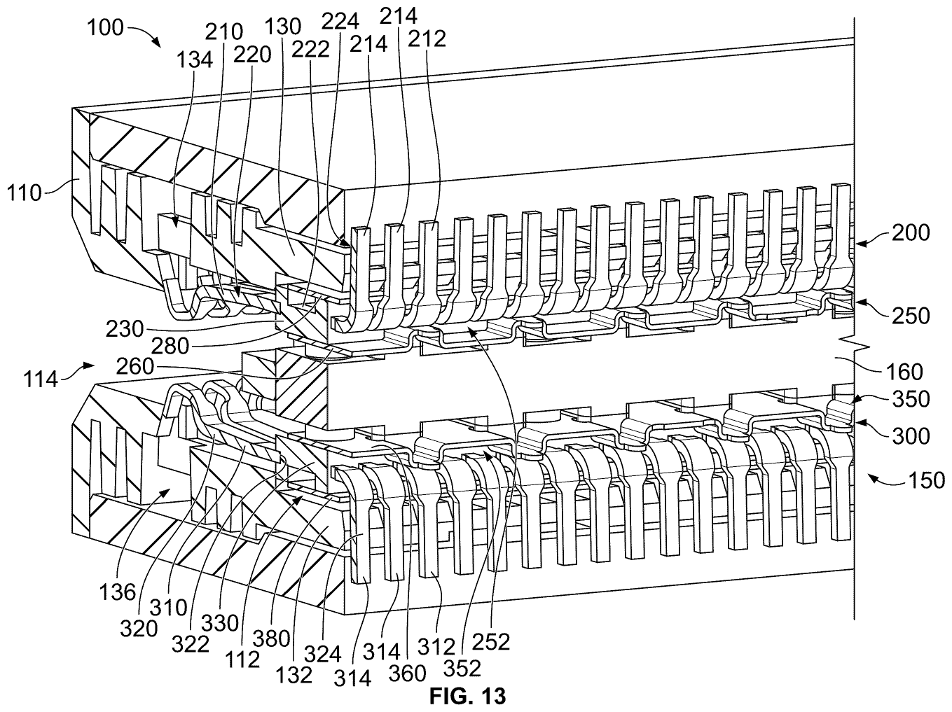

FIG. 11 is a perspective view of the inner side of the second contact subassembly 300 in accordance with an exemplary embodiment. FIG. 12 is a perspective view of an outer side of the second contact subassembly 300 in accordance with an exemplary embodiment. FIGS. 11 and 12 illustrate the inner and outer shields 360, 380 coupled to the inner and outer sides 334, 336 of the contact holder 330. The inner and outer shields 360, 380 provide shielding for the signal contacts 314. The inner and outer shields 360, 380 in addition to the ground contacts 312, provide circumferential shielding around each of the pairs of the signal contacts 314. For example, the ground contacts 312 provide shielding between the pairs of the signal contacts 314 and the inner and outer shields 360, 380 provide shielding along the inner and outer sides of the pair of the signal contacts 314.

When assembled, the inner shield 360 is coupled to the inner side 334 of the contact holder 330. In an exemplary embodiment, locating elements 346 extend from the inner side 334 of the contact holder 330. The locating elements 346 are received in the alignment openings 376 of the inner shield 360. The locating elements 346 may be used to locate and/or position the second contact subassembly 300 relative to the contact spacer 160 (shown in FIG. 2). The locating elements 346 may be posts or pins configured to be received in openings in the contact spacer 160. The locating elements 346 may be heat staked to the contact spacer 160. The locating elements 346 may include crush ribs to form an interference fit with the contact spacer 160. The inner shield 360 is coupled to the locating features 344. For example, the locating features 344 pass through the openings 371 in the inner shield 360. The covers 370 are located in the pockets 345 between the locating features 344. The connecting walls 372 extend into the opening 338 in the contact holder 330 to interface with the corresponding ground contacts 312. The connecting walls 372 may be welded, such as laser welded, to the ground contacts 312.

The inner shield 360 provides electrical shielding along the intermediate portions 322 of the signal contacts 314. For example, the inner shield 360 provides electrical shielding along the inner side 334 of the contact holder 330. The inner shield 360 may provide shielding below the bottom 341 of the contact holder 330 and/or above the top 340 of the contact holder 330. In the illustrated embodiment, the inner shield 360 extends to a location just below the top 340 of the contact holder 330, but extends for a distance below the bottom 341 of the contact holder 330 to provide shielding along portions of the terminating ends 324 of the signal contacts 314. The terminating elements 378 extend from the bottom of the inner shield 360 and are configured to be terminated to the host circuit board 30.

When assembled, the outer shield 380 is coupled to the outer side 336 of the contact holder 330. The outer shield 380 is coupled to the locating features 344. For example, the locating features 344 pass through the openings 391 in the outer shield 380. The covers 390 are located in the pockets 345 between the locating features 344. The connecting walls 392 extend into the opening 338 in the contact holder 330 to interface with the corresponding ground contacts 312. The connecting walls 392 may be welded, such as laser welded, to the ground contacts 312.

The outer shield 380 provides electrical shielding along the intermediate portions 322 of the signal contacts 314. For example, the outer shield 380 provides electrical shielding along the outer side 336 of the contact holder 330. The outer shield 380 may provide shielding below the bottom 341 of the contact holder 330 and/or above the top 340 of the contact holder 330. In the illustrated embodiment, the outer shield 380 extends to a location just below the top 340 of the contact holder 330, but extends for a distance below the bottom 341 of the contact holder 330 to provide shielding along portions of the terminating ends 324 of the signal contacts 314.

FIG. 13 is a sectional view of the card edge connector 100 in accordance with an exemplary embodiment. The card edge connector 100 includes the housing 110 and the contact assembly 150 received in the chamber 112 of the housing 110. The contact assembly 150 is aligned with the card slot 114 for mating the contacts 210 with the circuit card 52 (FIG. 1) when the circuit card 52 is plugged into the card slot 114.

When assembled, the contact spacer 160 is located between the first contact subassembly 200 and the second contact subassembly 300. The contact spacer 160 positions the first contact subassembly 200 relative to the second contact subassembly 300. For example, the contact spacer 160 holds the first contact holder 230 against a first wall 130 at a first side of the chamber 112 and holds the second contact holder 330 along a second wall 132 at a second side of the chamber 112. The contact spacer 160 is located between the inner shields 260, 360.

The first contacts 210 extend along the first wall 130 into contact pockets 134 formed in the first wall 130. The distal ends of the contacts 210 are located in the contact pockets 134 to prevent stubbing when the circuit card 52 is plugged into the card slot 114. In an exemplary embodiment, the first contacts 210 may be preloaded with an internal spring biasing force in an inward direction facing the card slot 114 to ensure that the mating ends of the first contact 210 interface with the circuit card 52 with the circuit card 52 is plugged into the card slot 114. The circuit card 52 may deflect the mating ends of the first contacts 210 outward when the circuit card 52 is plugged into the card slot 114, increasing the spring force of the spring beams against the circuit card 52 to maintain a reliable electrical connection between the first contact 210 and the circuit card 52.

The first shield structure 250 provides electrical shielding for the first signal contacts 214. For example, the first ground contacts 212 are located between the pairs of the first signal contacts 214 to provide shielding between the pairs of the first signal contacts 214. The inner shield 260 of the first shield structure 250 provides shielding along the inner side of the pair of the first signal contacts 214. The outer shield 280 of the first shield structure 250 provides shielding along the outer side of the pair of the first signal contacts 214. In an exemplary embodiment, the first shield structure 250 provides circumferential shielding around each pair of the first signal contacts 214. For example, shielding is provided 360° around each pair of the first signal contacts 214. The shielding is continuous around the pair of the first signal contacts 214 along the inner shield 260, through the flanking ground contacts 212, and along the outer shield 280. For example, the first shield structure 250 forms first shield tunnels 252 for each pair of the first signal contacts 214. The first shield tunnels 252 provide 360° shielding around the corresponding pair of the first signal contacts 214. The first shield structure 250 provide shielding along the intermediate portions 222 of the signal contacts 214, such as along the transition between the terminating ends 224 and the mating ends 220. The terminating ends 224 extend out of the first shield tunnels 252 for termination to the host circuit board 20. For example, the terminating ends 224 bend 90° at the bottom of the card edge connector 100 for surface mounted to the top surface of the host circuit board 20.

The second contacts 310 extend along the second wall 132 into contact pockets 136 formed in the second wall 132. The distal ends of the contacts 310 are located in the contact pockets 136 to prevent stubbing when the circuit card 52 is plugged into the card slot 114. In an exemplary embodiment, the second contacts 310 may be preloaded with an internal spring biasing force in an inward direction facing the card slot 114 to ensure that the mating ends of the second contact 310 interface with the circuit card 52 with the circuit card 52 is plugged into the card slot 114. The circuit card 52 may deflect the mating ends of the second contacts 310 outward when the circuit card 52 is plugged into the card slot 114, increasing the spring force of the spring beams against the circuit card 52 to maintain a reliable electrical connection between the second contact 310 and the circuit card 52.

The second shield structure 350 provides electrical shielding for the second signal contacts 314. For example, the second ground contacts 312 are located between the pairs of the second signal contacts 314 to provide shielding between the pairs of the second signal contacts 314. The inner shield 360 of the second shield structure 350 provides shielding along the inner side of the pair of the second signal contacts 314. The outer shield 380 of the second shield structure 350 provides shielding along the outer side of the pair of the second signal contacts 314. In an exemplary embodiment, the second shield structure 350 provides circumferential shielding around each pair of the second signal contacts 314. For example, shielding is provided 360° around each pair of the second signal contacts 314. The shielding is continuous around the pair of the second signal contacts 314 along the inner shield 360, through the flanking ground contacts 312, and along the outer shield 380. For example, the second shield structure 350 forms second shield tunnels 352 for each pair of the second signal contacts 314. The second shield tunnels 352 provide 360° shielding around the corresponding pair of the second signal contacts 314. The second shield structure 350 provides shielding along the intermediate portions 322 of the signal contacts 314, such as along the transition between the terminating ends 324 and the mating ends 320. The terminating ends 324 extend out of the second shield tunnels 352 for termination to the host circuit board 30. For example, the terminating ends 324 bend 90° at the bottom of the card edge connector 100 for surface mounted to the top surface of the host circuit board 30.

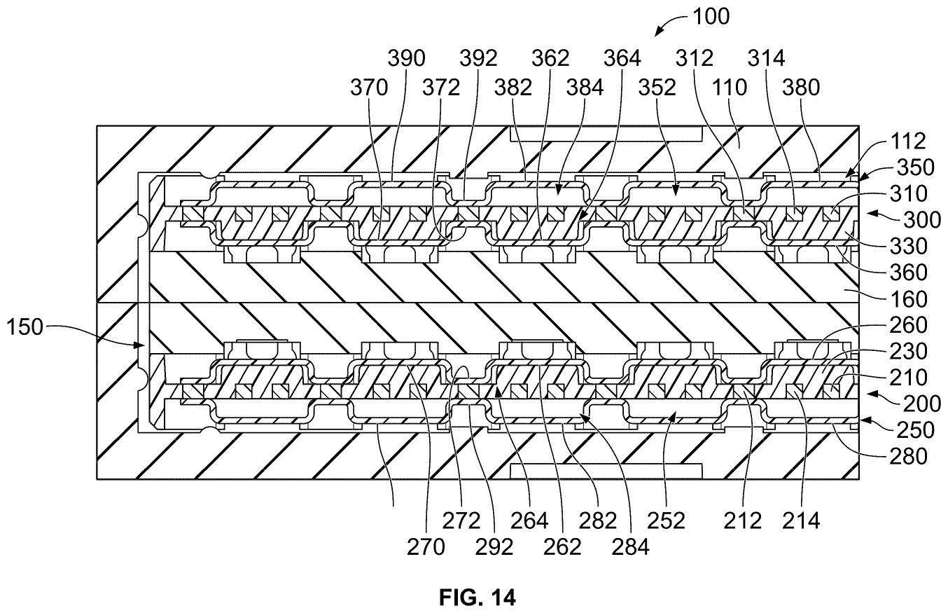

FIG. 14 is a cross-sectional view of a portion of the card edge connector 100 showing the contact assembly 150 in the chamber 112 of the housing 110. The contact spacer 160 is located between the first contact subassembly 200 and the second contact subassembly 300.

The first contact subassembly 200 includes the first contacts 210 arranged in a row held by the first contact holder 230. The first contact holder 230 holds relative positions of the first contacts 210. In an exemplary embodiment, the first contacts 210 include the first ground contacts 212 arranged in pairs and the first signal contacts 214 arranged between the first ground contacts 212. The first shield structure 250 is coupled to the first ground contacts 212 to provide circumferential shielding around each pair of the first signal contacts 214 through the first contact holder 230. For example, the connecting walls 272, 292 of the inner and outer shields 260, 280 are connected (for example, laser welded) to the opposite sides of the first ground contacts 212. The panels 262, 282 provide shielding along the inner and outer sides of the first contact subassembly 200. The panels 262, 282 are undulating to form the pockets 264, 284 for the first signal contacts 214 and the connecting walls 272, 292 for connecting to the first ground contacts 212.

The inner and outer shields 260, 280 and the first ground contacts 212 form the first shield tunnels 252 provide electrical shielding circumferentially around each of the pairs of the first signal contacts 214. For example, the first ground contacts 212 are located between the pairs of the first signal contacts 214. The inner covers 270 extend along the inner sides of the pair of the first signal contacts 214. The outer covers 290 extend along the outer sides of the pair of the first signal contacts 214. The covers 270, 290 form the pockets 264, 284, respectively, at respective inner and outer sides of the first signal contacts 214. The pockets 264, 284 may receive portions of the first contact holder 230 and/or may receive portions of the first signal contacts 214. The covers 270, 290 are spaced apart from the first signal contacts 214 by a space. The spacing may be selected to control an impedance. The first contact holder 230 may at least partially fill the space between the covers 270, 290 and the first signal contacts 214. Optionally, air may at least partially fill the space between the covers 270, 290 and the first signal contacts 214.

In an exemplary embodiment, the first shield structure 250 is a multipiece shield structure. For example, the first shield structure 250 includes the first inner shield 260 extending along the inner side of the first contact holder 230 and the first outer shield 280 extending along the outer side of the first contact holder 230. The inner shield 260 and the outer shield 280 provide shielding along opposite sides of the first signal contacts 214. The inner shield 260 and the outer shield 280 are electrically connected to each of the first ground contacts 212 to electrically common the first shield structure 250 and the first ground contacts 212.

The second contact subassembly 300 includes the second contacts 310 arranged in a row held by the second contact holder 330. The second contact holder 330 holds relative positions of the second contacts 310. In an exemplary embodiment, the second contacts 310 include the second ground contacts 312 arranged in pairs and the second signal contacts 314 arranged between the second ground contacts 312. The second shield structure 350 is coupled to the second ground contacts 312 to provide circumferential shielding around each pair of the second signal contacts 314 through the second contact holder 330. For example, the connecting walls 372, 392 of the inner and outer shields 360, 380 are connected (for example, laser welded) to the opposite sides of the second ground contacts 312. The panels 362, 382 provide shielding along the inner and outer sides of the second contact subassembly 300. The panels 362, 382 are undulating to form the pockets 364, 384 for the second signal contacts 314 and the connecting walls 372, 392 for connecting to the second ground contacts 312.

The inner and outer shields 360, 380 and the second ground contacts 312 form the second shield tunnels 352 provide electrical shielding circumferentially around each of the pairs of the second signal contacts 314. For example, the second ground contacts 312 are located between the pairs of the second signal contacts 314. The inner covers 370 extend along the inner sides of the pair of the second signal contacts 314. The outer covers 390 extend along the outer sides of the pair of the second signal contacts 314. The covers 370, 390 form the pockets 364, 384, respectively, at respective inner and outer sides of the second signal contacts 314. The pockets 364, 384 may receive portions of the second contact holder 330 and/or may receive portions of the second signal contacts 314. The covers 370, 390 are spaced apart from the second signal contacts 314 by a space. The spacing may be selected to control an impedance. The second contact holder 330 may at least partially fill the space between the covers 370, 390 and the second signal contacts 314. Optionally, air may at least partially fill the space between the covers 370, 390 and the second signal contacts 314.

In an exemplary embodiment, the second shield structure 350 is a multipiece shield structure. For example, the second shield structure 350 includes the second inner shield 360 extending along the inner side of the second contact holder 330 and the second outer shield 380 extending along the outer side of the second contact holder 330. The inner shield 360 and the outer shield 380 provide shielding along opposite sides of the second signal contacts 314. The inner shield 360 and the outer shield 380 are electrically connected to each of the second ground contacts 312 to electrically common the second shield structure 350 and the second ground contacts 312.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A card edge connector comprising:
a housing including a chamber and a card slot at a mating end of the housing configured to receive a card edge of a circuit card, the housing configured to be mounted to the host circuit board; and
a contact assembly received in the chamber for connection to the card edge plugged into the card slot, the contact assembly including a first contact subassembly and a second contact subassembly;
the first contact subassembly including an array of first contacts held by a first contact holder, the first contacts passing through the first contact holder, the first contacts including first ground contacts and first signal contacts, the first signal contacts arranged in pairs, the first ground contacts located between the pairs of the first signal contacts, the first contact subassembly including a first shield structure coupled to the first ground contacts, the first shield structure and the first ground contacts providing circumferential shielding around each pair of the first signal contacts through the first contact holder, the first shield structure configured to directly electrically connect to the host circuit board;
the second contact subassembly including an array of second contacts held by a second contact holder, the second contacts passing through the second contact holder, the second contacts including second ground contacts and second signal contacts, the second signal contacts arranged in pairs, the second ground contacts located between the pairs of the second signal contacts, the second contact subassembly including a second shield structure coupled to the second ground contacts, the second shield structure and the second ground contacts providing circumferential shielding around each pair of the second signal contacts through the second contact holder, the second shield structure configured to directly electrically connect to the host circuit board.

2. The card edge connector of claim 1, wherein the first shield structure includes first shield tunnels, each first shield tunnel receiving the first contact holder and the corresponding pair of the first signal contacts, and wherein the second shield structure includes second shield tunnels, each second shield tunnel receiving the second contact holder and the corresponding pair of the second signal contacts.

3. The card edge connector of claim 1, wherein the first shield structure is spaced apart from the first signal contacts by a space, the first contact holder at least partially filling the space between the first shield structure and the first signal contacts, and wherein the second shield structure is spaced apart from the second signal contacts by a space, the second contact holder at least partially filling the space between the second shield structure and the second signal contacts.

4. The card edge connector of claim 1, wherein the first shield structure includes a first inner shield coupled to an inner side of the first contact holder and a first outer shield coupled to an outer surface of the first contact holder, the first inner shield and the first outer shield coupled to the first ground contacts, and wherein the second shield structure includes a second inner shield coupled to an inner side of the second contact holder and a second outer shield coupled to an outer surface of the second contact holder, the second inner shield and the second outer shield coupled to the second ground contacts.

5. The card edge connector of claim 4, wherein the first inner shield and the first outer shield are coupled to opposite sides of each of the first ground contacts, and wherein the second inner shield and the second outer shield are coupled to opposite sides of each of the second ground contacts.

6. The card edge connector of claim 4, wherein the first inner shield includes a panel including pockets, each pocket receiving the first contact holder and the corresponding pair of the first signal contacts, and wherein the first outer shield includes a panel including pockets, each pocket receiving the first contact holder and the corresponding pair of the first signal contacts, and wherein the second inner shield includes a panel including pockets, each pocket receiving the second contact holder and the corresponding pair of the second signal contacts, and wherein the second outer shield includes a panel including pockets, each pocket receiving the second contact holder and the corresponding pair of the second signal contacts.

7. The card edge connector of claim 4, wherein the first inner shield includes a series of covers and connecting walls between the covers, the connecting walls being joined to the corresponding first ground contacts, the covers forming pockets between the connecting walls, each pocket receiving the first contact holder and the corresponding pair of the first signal contacts, and wherein the first outer shield includes a series of covers and connecting walls between the covers, the connecting walls being joined to the corresponding first ground contacts, the covers forming pockets between the connecting walls, each pocket receiving the first contact holder and the corresponding pair of the first signal contacts, and wherein the second inner shield includes a series of covers and connecting walls between the covers, the connecting walls being joined to the corresponding second ground contacts, the covers forming pockets between the connecting walls, each pocket receiving the second contact holder and the corresponding pair of the second signal contacts, and wherein the second outer shield includes a series of covers and connecting walls between the covers, the connecting walls being joined to the corresponding second ground contacts, the covers forming pockets between the connecting walls, each pocket receiving the second contact holder and the corresponding pair of the second signal contacts.

8. The card edge connector of claim 1, wherein the first ground contacts include terminating ends configured to be coupled to the host circuit board, the first shield structure including terminating elements configured to be coupled to the host circuit board, and wherein the second ground contacts include terminating ends configured to be coupled to the host circuit board, the second shield structure including terminating elements configured to be coupled to the host circuit board.

9. The card edge connector of claim 1, wherein the contact assembly includes a contact spacer positioned between the first contact subassembly and the second contact subassembly.

10. The card edge connector of claim 9, wherein the contact spacer is located between the first shield structure and the second shield structure.

11. A card edge connector comprising:
a housing including a chamber and a card slot at a mating end of the housing configured to receive a card edge of a circuit card, the housing configured to be mounted to the host circuit board; and
a contact assembly received in the chamber for connection to the card edge plugged into the card slot, the contact assembly including a contact subassembly including an array of contacts held by a contact holder, the contact holder including an inner side and an outer side, the contacts passing through the contact holder generally parallel to the inner side and the outer side, the contacts including ground contacts and signal contacts, the signal contacts arranged in pairs, the ground contacts located between the pairs of the signal contacts, the contact subassembly including an inner shield arranged at the inner side and an outer shield arranged at the outer side, the inner shield including inner connecting elements electrically connected to the ground contacts, the outer shield including outer connecting elements electrically connected to the ground contacts, the inner shield configured to be directly electrically connected to the host circuit board.

12. The card edge connector of claim 11, wherein the inner shield, the outer shield, and the ground contacts form shield tunnels providing circumferential shielding, each shield tunnel receiving the corresponding pair of the signal contacts.

13. The card edge connector of claim 11, wherein the signal contacts including mating ends, terminating ends, and intermediate portions between the mating ends and the terminating ends, the intermediate portions passing through the contact holder, the mating ends extending from the contact holder for mating with the circuit card, the terminating ends extending from the contact holder for terminating to a host circuit board, the inner shield and the outer shield providing shielding along the intermediate portions.

14. The card edge connector of claim 11, wherein the inner shield includes a panel including pockets, each pocket receiving the contact holder and the corresponding pair of the signal contacts, and wherein the outer shield includes a panel including pockets, each pocket receiving the contact holder and the corresponding pair of the signal contacts.

15. The card edge connector of claim 11, wherein the inner shield includes a series of covers and connecting walls between the covers, the connecting walls being joined to the corresponding ground contacts, the covers forming pockets between the connecting walls, each pocket receiving the contact holder and the corresponding pair of the signal contacts, and wherein the outer shield includes a series of covers and connecting walls between the covers, the connecting walls being joined to the corresponding ground contacts, the covers forming pockets between the connecting walls, each pocket receiving the contact holder and the corresponding pair of the signal contacts.

16. The card edge connector of claim 13, wherein each cover includes a cover wall and side walls extending from opposites sides of the cover wall between the cover wall and the corresponding connecting walls.

17. A card edge connector comprising:
a housing including a chamber and a card slot at a mating end of the housing configured to receive a card edge of a circuit card; and
a contact assembly received in the chamber for connection to the card edge plugged into the card slot, the contact assembly including a first contact subassembly and a second contact subassembly;
the first contact subassembly including an array of first contacts held by a first contact holder, the first contacts passing through the first contact holder, the first contact holder including a first inner side and a first outer side, the first contacts passing through the first contact holder generally parallel to the first inner side and the first outer side, the first contacts including first ground contacts and first signal contacts, the first signal contacts arranged in pairs, the first ground contacts located between the pairs of the first signal contacts, the first contact subassembly including a first inner shield arranged at the first inner side and a first outer shield arranged at the first outer side, the first inner shield including first inner connecting elements electrically connected to the first ground contacts, the first outer shield including first outer connecting elements electrically connected to the first ground contacts, the first inner shield, the first outer shield, and the first ground contacts providing circumferential shielding around each pair of the first signal contacts through the first contact holder;
the second contact subassembly including an array of second contacts held by a second contact holder, the second contacts passing through the second contact holder, the second contact holder including a second inner side and a second outer side, the second contacts passing through the second contact holder generally parallel to the second inner side and the second outer side, the second contacts including second ground contacts and second signal contacts, the second signal contacts arranged in pairs, the second ground contacts located between the pairs of the second signal contacts, the second contact subassembly including a second inner shield arranged at the second inner side and a second outer shield arranged at the second outer side, the second inner shield including second inner connecting elements electrically connected to the second ground contacts, the second outer shield including second outer connecting elements electrically connected to the second ground contacts, the second inner shield, the second outer shield, and the second ground contacts providing circumferential shielding around each pair of the second signal contacts through the second contact holder.

18. The card edge connector of claim 17, wherein the first inner shield and the first outer shield forming first shield tunnels, each first shield tunnel receiving the first contact holder and the corresponding pair of the first signal contacts, and wherein the second inner shield and the second outer shield forming second shield tunnels, each second shield tunnel receiving the second contact holder and the corresponding pair of the second signal contacts.

19. The card edge connector of claim 17, wherein the first inner shield includes a panel including pockets, each pocket receiving the first contact holder and the corresponding pair of the first signal contacts, and wherein the first outer shield includes a panel including pockets, each pocket receiving the first contact holder and the corresponding pair of the first signal contacts, and wherein the second inner shield includes a panel including pockets, each pocket receiving the second contact holder and the corresponding pair of the second signal contacts, and wherein the second outer shield includes a panel including pockets, each pocket receiving the second contact holder and the corresponding pair of the second signal contacts.

20. The card edge connector of claim 17, wherein the first inner shield includes a series of covers and connecting walls between the covers, the connecting walls being joined to the corresponding first ground contacts, the covers forming pockets between the connecting walls, each pocket receiving the first contact holder and the corresponding pair of the first signal contacts, and wherein the first outer shield includes a series of covers and connecting walls between the covers, the connecting walls being joined to the corresponding first ground contacts, the covers forming pockets between the connecting walls, each pocket receiving the first contact holder and the corresponding pair of the first signal contacts, and wherein the second inner shield includes a series of covers and connecting walls between the covers, the connecting walls being joined to the corresponding second ground contacts, the covers forming pockets between the connecting walls, each pocket receiving the second contact holder and the corresponding pair of the second signal contacts, and wherein the second outer shield includes a series of covers and connecting walls between the covers, the connecting walls being joined to the corresponding second ground contacts, the covers forming pockets between the connecting walls, each pocket receiving the second contact holder and the corresponding pair of the second signal contacts.
